(19) United States
(12) Patent Application Publication
(10) Pub. No.: US 2026/0017841 A1
(43) Pub. Date: Jan. 15, 2026

(54) AUTOREGRESSIVE LANGUAGE MODELS FOR VIDEO GENERATION

(71) Applicant: Lemon Inc., Grand Cayman (KY)

(72) Inventors: Daquan Zhou, Los Angeles, CA (US); Zhijie Lin, Singapore (SG); Bingyi Kang, Los Angeles, CA (US); Yang Zhao, Singapore (SG); Jiashi Feng, Singapore (SG)

(21) Appl. No.: 18/773,329

(22) Filed: Jul. 15, 2024

(51) Int. Cl. G06T 11/00; G06F 40/284

(52) U.S. Cl. CPC G06T 11/00; G06F 40/284; G06T 2211/441

(57) ABSTRACT

Implementations for autoregressively generating a video using a video generation model are provided. One aspect includes a method comprising: performing a progressive multi-stage training process comprising a first stage and a second stage, wherein: the first stage comprises training the video generation model to perform text-to-image generation; and the second stage comprises further training the video generation model using a training dataset comprising labeled video-text pairs, wherein further training the video generation model comprises: for each of the labeled video-text pair: generating at least one text token using a text tokenizer and a text annotation of the labeled video-text pair; generating a plurality of video tokens using a video tokenizer and a video of the labeled video-text pair; autoregressively generating frame tokens using the at least one text token; and training the video generation model using loss values calculated from the frame tokens and the video tokens.

### BACKGROUND

Categories of video generation methods include generative adversarial network (GAN)-based, diffusion-based, and language-model-based methodologies. Among them, diffusion-based methods have recently attracted great attention. Most diffusion-based methods encode videos into latent space for efficient training and utilize progressive inference strategies to generate videos with high spatial-temporal resolution. Language models have recently been explored for visual generation, focusing on tokenizing visual data into a form that can be processed by these models. Quantization techniques are commonly used, and transformers are employed to model the resulting tokens.

For image generation, autoregressive or masked transformers are prevalent. In short video generation, image-level or video-level tokenizers are utilized, incorporating spatial-temporal compression and causal structures. However, short video generation models generally focus on producing clips (e.g., videos with durations under 10 seconds that are typically of 1-3 seconds in length), limiting their ability to capture complex events and maintain consistency over longer durations. Previous works have explored long video generation (e.g., videos with durations longer than ten seconds) using various approaches. More recently, video diffusion models have been extended for long video generation. Some methods focus on sampling noise vectors and aggregating overlapping short video segments, respectively. Other methods propose an autoregressive approach with memory blocks for consistency and appearance preservation. In the language model domain, methods capable of generating variable-length videos using a masked video transformer have been contemplated. However, despite these advancements, generating long videos with rich motion dynamics, consistent appearance, and high visual quality in the open domain remains a challenge.

### SUMMARY

Implementations for autoregressively generating a video using a video generation model are provided. One aspect includes a method comprising: performing a progressive multi-stage training process comprising a first stage and a second stage, wherein: the first stage comprises training the video generation model to perform text-to-image generation; and the second stage comprises further training the video generation model using a training dataset comprising labeled video-text pairs, wherein further training the video generation model comprises: for each of the labeled video-text pair: generating at least one text token using a text tokenizer and a text annotation of the labeled video-text pair; generating a plurality of video tokens using a video tokenizer and a video of the labeled video-text pair; autoregressively generating frame tokens using the at least one text token; and training the video generation model using loss values calculated from the frame tokens and the video tokens.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a schematic view of an example computing system for training an autoregressive video generation model.

FIG. 2 shows a data flow diagram of an example training process of an autoregressive video generator, which can be implemented using the computer system of FIG. 1.

FIG. 3 shows a graph depicting training loss for different frame ranges.

FIG. 4 shows a process flow diagram of an example method for training an autoregressive video generation model, which can be implemented using the computer system of FIG. 1.

FIG. 5 shows a process flow diagram of an example method for generating a video using an autoregressive video generation model, which can be implemented using the trained model of FIG. 1.

FIG. 6 shows a schematic view of an example computing environment in which the computer system of FIG. 1 may be enacted.

### DETAILED DESCRIPTION

Video generation models, including diffusion-based and language model-based approaches, are highly capable of generating short videos (e.g., videos with durations under 10 seconds that are typically of 1-3 seconds in length). To capture more comprehensive content, it is desirable to generate long videos (e.g., videos with durations longer than 10 seconds and can include minute-level videos) with consistent appearance, larger motion dynamics, and natural scene transitions. Autoregressive generative language models have shown success in generating long and coherent text sequences, demonstrating their ability to capture long-range dependencies and complex temporal patterns. However, the use of autoregressive generative language models for video generation is limited to generating short videos of several seconds.

In natural language processing, generative language models can be trained on long sequences and extended beyond the training length. However, training autoregressive generative language models on long video sequences or extending short video generators to generate long videos would lead to unsatisfactory performance for minute-level video generation. The main obstacles are the large redundancy and strong inter-frame dependency among video tokens. The video tokens of the current frame depend heavily on the tokens of the previous frames, leading to two challenges for long video generation. The first challenge is the imbalance of loss during training. When trained with the next-token prediction objective, predicting early-frame tokens from text prompts is much more difficult than predicting late-frame tokens based on the ground-truth tokens of previous frames. The imbalanced difficulty of tokens of different stages lead to imbalanced loss during training. The issue becomes more severe as the video length increases, where the accumulated loss of many easy tokens largely surpasses the loss of a few difficult tokens and dominates the gradient direction. The second challenge includes error accumulation during inference. While the model predicts the next token conditioned on previous ground-truth tokens during training, it has to predict the next token conditioned on previous predicted tokens during inference. This training-inference discrepancy leads to error accumulation during inference. Because of the strong inter-frame dependency among video tokens and the large number of video tokens, such error accumulation is non-negligible and can cause visual quality degradation for long video inference.

In view of the observations above, implementations of autoregressive generative language models for long video generation are provided. As described herein, novel implementations of an autoregressive generative language model based video generator can be employed to generate content-rich, coherent, and dynamic long videos in the scale of minutes. In some implementations, the autoregressive generative language model based video generator is trained on ten-second videos and can, as such, generate ten-second videos. This capability can be extended to generate minute-level long videos conditioned on text prompts.

Autoregressive generative language model based video generators as described herein generally include two components: a video tokenizer that compresses videos into sequences of discrete video tokens, and an autoregressive generative language model that models the unified sequence of text tokens followed by the video tokens through next-token prediction. The autoregressive generative language model can have a transformer architecture. To mitigate the problem of imbalanced loss for long video training, a progressive short-to-long training strategy that gradually increases the training video length can be implemented. Furthermore, loss re-weighting can be performed for early frames to prevent the model from being dominated by many easy-difficulty tokens in the late frames. Inference strategies, including the video token re-encoding and sampling strategy, can be implemented to further extend the video length by iteratively generating the next frames conditioned on previously generated frames. To enable training and inference with longer videos, the autoregressive generative language model based video generator can be implemented to adopt low-resolution videos (e.g., 128×128 pixels). A super-resolution and refinement module can be utilized to enhance the resolution and fine-grained details of the generated low-resolution videos.

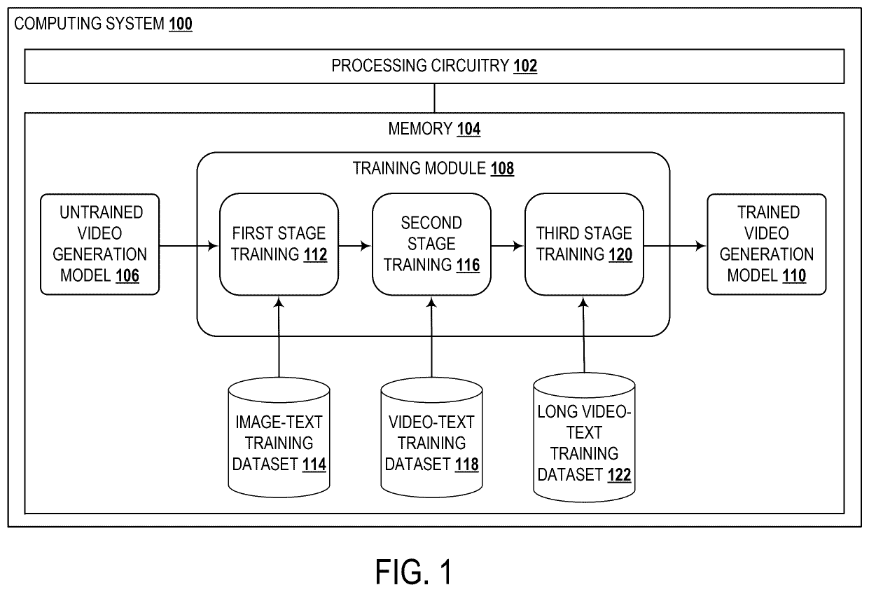

Turning now to the figures, autoregressive generative language model based video generators and related implementations are described in further detail. FIG. 1 shows a schematic view of an example computing system 100 for training an autoregressive video generation model. The example computing system 100 can be implemented with various types of computing devices and across multiple such devices, including mobile devices, smart phones, personal computers, laptops, computing servers, etc. The example computing system 100 includes processing circuitry 102 and memory 104 storing instructions that, during execution, causes the processing circuitry 102 to perform the various processes described herein.

The memory 104 stores an untrained video generation model 106. Various types of models can be implemented. In the depicted example, the untrained video generation model 106 is an autoregressive generative language model based model capable of text-to-video generation. The video generation model 106 includes a text tokenizer that converts text, such as text prompts, into text tokens. A video tokenizer capable of encoding videos into discrete video tokens can also be utilized. Together, the text and video tokens can be modeled as a unified sequence. The video generation model 106 can further include a decoder-only transformer that enables video generation by autoregressively predicting video tokens conditioned on the text tokens and, if any, previous video tokens. The text tokenizer and video tokenizer can be implemented in various ways. In some implementations, the video tokenizer leverages causal 3D convolutional neural network (CNN) architecture to provide spatial-temporal joint compression and joint modeling of images and videos.

The untrained video generation model 106 is passed through a training module 108 that trains the model 106 to produce a trained video generation model 110. To extend the temporal coverage of videos within a limited number of tokens, the video generation model 106 can be configured to train on and to generate low-resolution videos, and super-resolution can be performed during post-processing. In the depicted example, the training module 108 performs a multi-stage training process for long videos. As described above, there is an imbalanced loss problem for long-sequence training. During training, the model learns through next-token prediction. Generally, it is much easier to predict tokens of later frames given the previous ground-truth video and text tokens. In comparison, predicting early-frame tokens with little visual cues from previous frames is more challenging. The accumulated loss of the many easy-to-predict tokens from later frames surpasses the loss of the few difficult-to-predict tokens from early frames and dominates the gradient direction, leading to suboptimal visual quality in the generated videos.

To mitigate the aforementioned challenge of imbalanced loss, the training module 108 implements a multi-stage progressive short-to-long training strategy that allows the model 106 to first learn the text-conditioned appearance and motion of short videos, and then smoothly adjust to longer-range dependencies and more complex motion patterns in longer videos. In the depicted example, the training module 108 implements training in three stages with increasing training video length. In the first stage training process 112, the model 106 is trained with text-to-image generation, which helps the model to establish a strong foundation for modeling per-frame appearance and structure. In the depicted example, the first stage training process 112 trains the model 106 on a training dataset of static image-text labeled data 114. In the second stage training process 116, the model 106 is trained on short video clips provided by a video-text training dataset 118. During this stage, the model 106 learns to capture short-term temporal dependencies and motion patterns while preserving the per-frame visual quality. The short video clips can be of various lengths. In some implementations, the short video clips have seventeen frames. In the third stage training process 120, the model 106 is trained on long videos from a long video-text training dataset 122. A long video of the long video-text training dataset 122 can be any video longer than the video clips used during the second stage training process 116. In some implementations, the long video-text training dataset 122 includes long videos with sixty-five frames. In some implementations, the long video-text training dataset 122 includes long videos with durations of at least ten seconds.

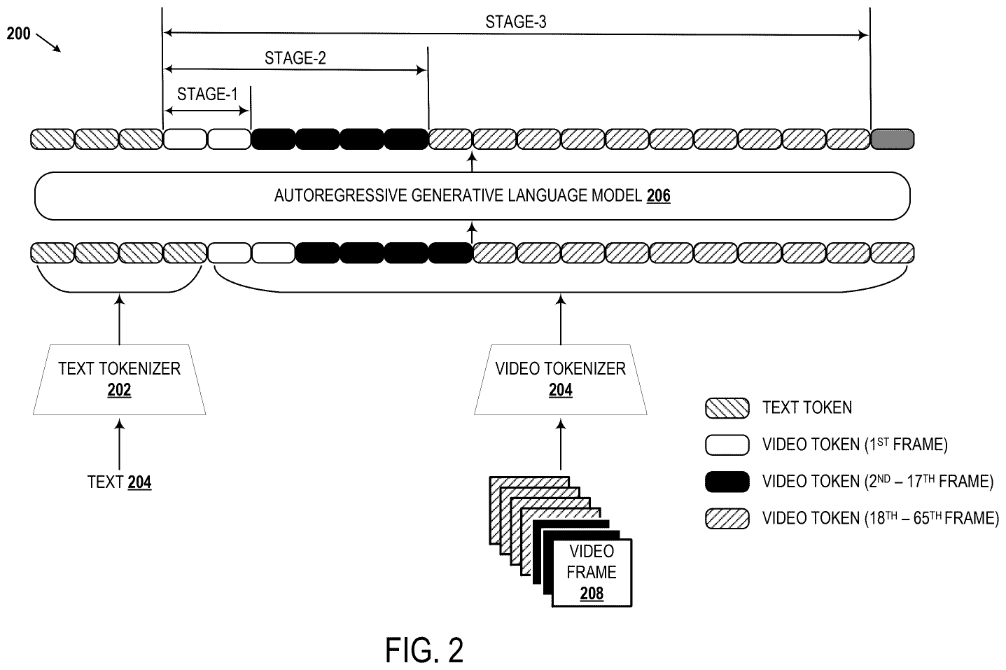

FIG. 2 shows a data flow diagram of an example training process 200 of an autoregressive video generator. The example training process 200 can be implemented by, for example, the training module 108 of FIG. 1. The overall framework includes a text tokenizer 202 and a video tokenizer 204 for encoding input text 206 and input video frames 208, respectively. The text and video tokenizers can be implemented in various ways. In some implementations, the video tokenizer 204 implements causal 3D CNN architecture that provides spatial-temporal joint compression and joint modeling of images and videos. The encoded spatial-temporal features can be quantized into discrete tokens. Performance of the video tokenizer 204 can depend on its implementation and its training. For example, in some implementations, the video tokenizer 204 can compress a ten-second video (65 frames, 128×128 resolution for each frame) into a sequence of 17×16×16 discrete tokens with a vocabulary size of 8192.

The framework further includes an autoregressive generative language model 210 with a decoder-only transformer that autoregressively predicts next video tokens based on text tokens and, if any, previous video tokens. With the video frames 208 converted into discrete tokens by the video tokenizer 204, the text and video tokens can be modeled as a unified token sequence for video generation. In some implementations, causal attention is applied to the unified token sequence (i.e., all tokens). Text-to-video generation can be performed by autoregressively predicting video tokens conditioned on the text tokens with a decoder-only transformer. For simplicity, special separate tokens are omitted in the following formulation. Let t={t₁, t₂, . . . , t_{N}} represent the sequence of text tokens, where N is the number of text tokens. Let v={v₁, v₂, . . . , v_{L}} represent the sequence of video tokens, where L is the number of video tokens. The autoregressive generative language model 206 models the unified token sequence s=[t; v] and is trained with the next-token prediction loss for the video tokens:

$$ℒ = - {\sum }_{i = 1}^{L} log p ( {v}_{i} \vert {v}_{< i} , t ) \qquad ( 1 )$$

where vᵢ denotes the i-th token in the video sequence v, and v_{<i} denotes all the video tokens preceding vᵢ.

Video generation models trained on short video clips (e.g., videos with durations of less than ten seconds) are generally limited in their ability to capture long-term dependencies and complex dynamics in longer videos (e.g., videos with durations of at least ten seconds). In theory, training these models on videos with longer durations would enable them to learn and generate more coherent and contextually rich video content. However, training directly on long videos leads to suboptimal performance, even when the model is trained for a large number of iterations. During training, the model learns through next-token prediction where it is much easier to predict tokens of later frames given the previous ground-truth video and text tokens. In comparison, predicting early-frame tokens with little visual cues from previous frames is more challenging.

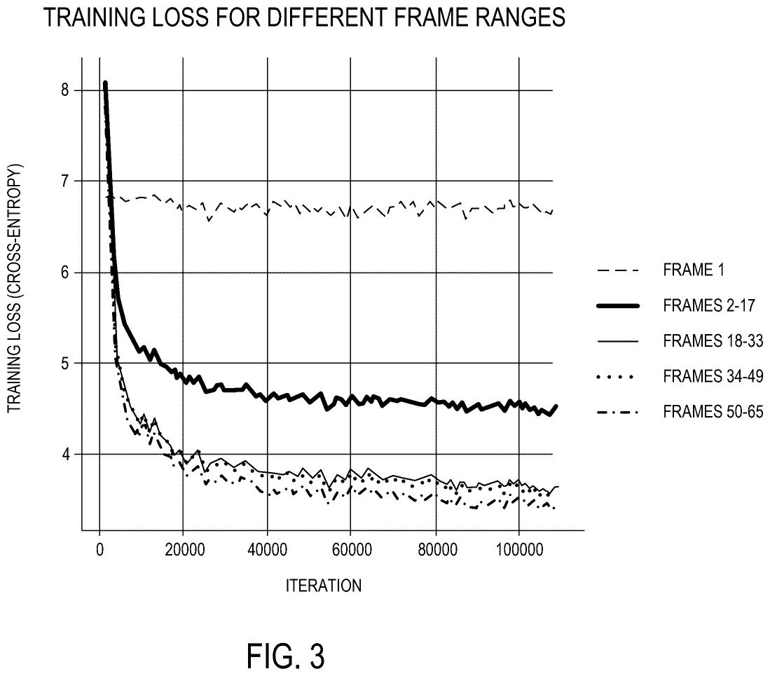

FIG. 3 shows a graph depicting training loss for different frame ranges. The loss curve of different frame ranges ware shown for training on videos with sixty-five frames (with 4,356 tokens, covering ten seconds). As shown, tokens from early frames (frames 1-17) have larger losses than those from later frames. Tokens from frames 50-65 have the smallest average loss. This imbalanced loss is a problem for long-sequence training, because the accumulated loss of the many easy-to-predict tokens from later frames (e.g., frames 18-65) surpasses the loss of the few difficult-to-predict tokens from early frames (e.g., frames 1-17) and dominates the gradient direction, leading to suboptimal visual quality in the generated videos.

To mitigate the aforementioned challenge of imbalanced video token difficulties, a progressive short-to-long training strategy with loss reweighting can be implemented. Referring back to FIG. 2, the example training process 200 implements a progressive short-to-long training scheme with three stages with gradually increasing training video length. The multi-stage training scheme allows the model 206 to first learn the text-conditioned appearance and motion of short videos, and then smoothly adjust to longer-range dependencies and more complex motion patterns in longer videos. In stage-1, the model 206 is trained with text-to image generation on a large dataset of static images, which helps the model to establish a strong foundation for modeling per-frame appearance and structure. In stage-2, the model 206 continues to train jointly on images and short video clips of seventeen frames, where the model learns to capture short-term temporal dependencies and motion patterns while preserving the per-frame visual quality. In stage-3, the number of video frames is increased to sixty-five, covering a temporal range of ten seconds. Other training schemes can also be implemented. For example, different types and numbers of stages can be implemented. Stages training with different frame lengths can be implemented. In some implementations, the training process is a progressive training scheme with two stages.

In some implementations, the example training process 200 is implemented with a loss re-weighting scheme, which facilitates training on long videos (e.g., ten-second videos). To further strengthen the supervision of early frames and to prevent the model 206 from forgetting the stage-1 and stage-2 priors, the loss re-weighting scheme can be applied for stage-3. In some implementations, larger loss weights are applied for the tokens of early frames. In one example, the overall weighted loss is formulated as:

$${ℒ}_{weighted} = - ( 1 + λ ) {\sum }_{i = 1}^{K} log p ( {v}_{i} \vert {v}_{< i} , t ) - {\sum }_{i = K + 1}^{L} log p ( {v}_{i} \vert {v}_{< i} , t ) \qquad ( 2 )$$

where the first term denotes the loss for the K tokens corresponding to the early frames (e.g., frames 1-17), and the second term denotes the loss for the L-K tokens corresponding to the later frames (e.g, frames 18-65). λ is a positive value to strengthen the loss weight of early frames.

With the loss weighting and progressive training strategy, the model 206 can effectively mitigate the issues of long video training discussed above. As the model 206 is trained on a temporal range of ten seconds, it can generate videos of up to ten seconds with improved temporal coherence and consistency while maintaining the strong appearance and motion priors learned from the images and short video clips. In some implementations, inference strategies are applied to extend the generated video length to the minute level. Many generative language models are length-generalizable, and it can be expected that an generative language model based video generator trained on ten-second videos can be extended to generate longer videos autoregressively. However, generalizing beyond the training video duration is non-trivial and may lead to error accumulation and quality degradation. For instance, a one-minute video corresponds to significantly longer token sequences (e.g., approximately 26,112 video tokens under the settings of FIG. 2) than most text sequences typically encountered in language modeling tasks. The considerable length and the large interframe dependency among video tokens pose challenges for extending the generative language model based generator for long video generation.

One way of extending videos beyond the training duration is to exploit the benefit of autoregressive language models by iteratively generate the tokens of the next video clip, conditioned on the text prompts and the previously generated tokens of the current video clip. However, this strategy leads to video quality degradation for video frames beyond the training range. The issue stems from the token misalignment caused by the causal video tokenizer. The tokens from the last n frames in a video clip are derived based on the context of all previous frames, while the tokens from the first n frames in a new video clip are derived without the context of the previous video clip. Therefore, generating tokens for the new clip directly conditioned on previous tokens leads to distribution shift in the input features for generative language models. To address this issue, the generative language model-generated video tokens can be decoded to pixel-space videos and the last n frames can be re-encoded with the video tokenizer. The re-encoded video tokens and the text tokens serve as the conditions to generate the tokens of the next video clip.

Decoding video tokens with autoregressive language models is prone to error accumulation because of the autoregressive nature of the model and the strong inter-frame dependencies of video tokens. Errors in predicting one token can propagate and influence the generation of subsequent tokens, leading to a degradation in video quality as the length increases. To mitigate this issue, a top-k sampling strategy can be utilized. During the token sampling process, the top-k most probable tokens can be sampled, the influence of potential errors on subsequent token generation can be reduced, alleviating the error accumulation problem. Too small values of k (e.g., k=1) lead to almost static videos with little motion. To balance dynamic motion and error accumulation, higher values (e.g., k=50) can be chosen.

The video tokenizer 204 and generative language model based model 206 can be configured to operate on various resolutions. To enable training and inference with longer videos, low-resolutions can be utilized. This design trades off spatial resolution for longer video sequences during training and inference. In some implementations, the video tokenizer 204 and generative language model based model 206 operate on a resolution of 128×128. During inference, post-processing techniques can be applied to enhance the spatial resolution of generated videos (e.g., super-resolution techniques) without affecting the content and motion of the videos.

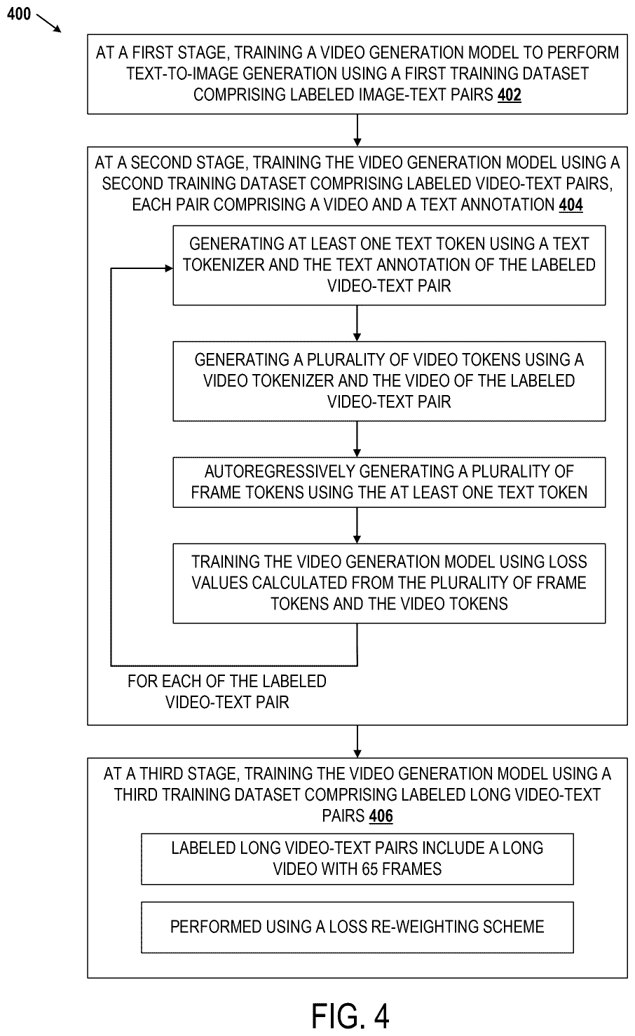

FIG. 4 shows a process flow diagram of an example method 400 for training an autoregressive video generation model. Various types of video generation models can be utilized. In some implementations, an autoregressive generative language model based model is implemented. The example method 400 implements a progressive multi-stage training process that includes multiple stages. Any number of stages can be implemented. In some implementations, the progressive multi-stage training process includes at least two stages. In further implementations, the progressive multi-stage training process includes at least three stages. Each stage can be configured to train the video generation model on different datasets with images and/or videos of different durations.

The example method 400 includes, at step 402, a first stage that includes training a video generation model to perform text-to-image generation using a first training dataset. The first training dataset can be implemented in various ways. In some implementations, the first training dataset includes labeled image-text pairs. For example, the first training dataset can include images paired with annotations describing their respective image. During training, the annotations provide the text prompt to the video generation model, and the associated image provides the ground-truth label.

The example method 400 includes, at step 404, a second stage that includes training the video generation model using a second training dataset that includes labeled video-text pairs. Each labeled video-text pair includes a video with an associated text annotation. The labeled video-text pairs can include videos with similar durations. In some implementations, the labeled video-text pairs include videos with seventeen frames.

For each of the labeled video-text pair, a training loop can be performed. The training loop for using the second training dataset can include generating at least one text token using a text tokenizer and the text annotation of the labeled video-text pair. The text tokenizer can be implemented to parse and split input text into text tokens. Any type of text tokenizer can be utilized. The training loop for using the second training dataset can further include generating a plurality of video tokens using a video tokenizer and the video of the labeled video-text pair. The video tokenizer can be implemented to encode and compress input video frames into video tokens. In some implementations, the video tokenizer outputs fewer tokens than the number of input frames. In some implementations, the video tokenizer 204 can compress a ten-second video (65 frames, 128×128 resolution for each frame) into a sequence of 17×16×16 discrete tokens with a vocabulary size of 8192. Any type of video tokenizer can be utilized. For example, the video tokenizer can include a trained CNN architecture.

The training loop for using the second training dataset can further include autoregressively generating a plurality of frame tokens using the at least one text token. In some implementations, a decoder-only transformer is utilized to autoregressively predicts next video tokens based on a token sequence, which can include text tokens and previous video tokens. For example, the process can include predicting a first frame based on the text tokens. Successive frames can be autoregressively predicted based on the text tokens and previously generated frames. The video generation model can then be trained using loss values calculated from the plurality of frame tokens and the video tokens.

The example method 400 includes, at step 406, a third stage that includes training the video generation model using a third training dataset that includes labeled long video-text pairs. The third stage can be implemented similarly as the second stage but with a different dataset with longer-duration videos. In some implementations, the training process using the third training dataset includes a loss re-weighting scheme. For example, larger loss weights can be applied to tokens of early frames compared to later frames. Various types of training datasets can be utilized. In some implementations, the labeled long-video-text pairs include long videos that each have more frames than the videos utilized in the second training dataset. In further implementations, the long videos each have sixty-five frames. Alternatively, the long videos can be described in terms of duration. In some implementations, the labeled long-video-text pairs include long videos that each have a duration of at least ten seconds.

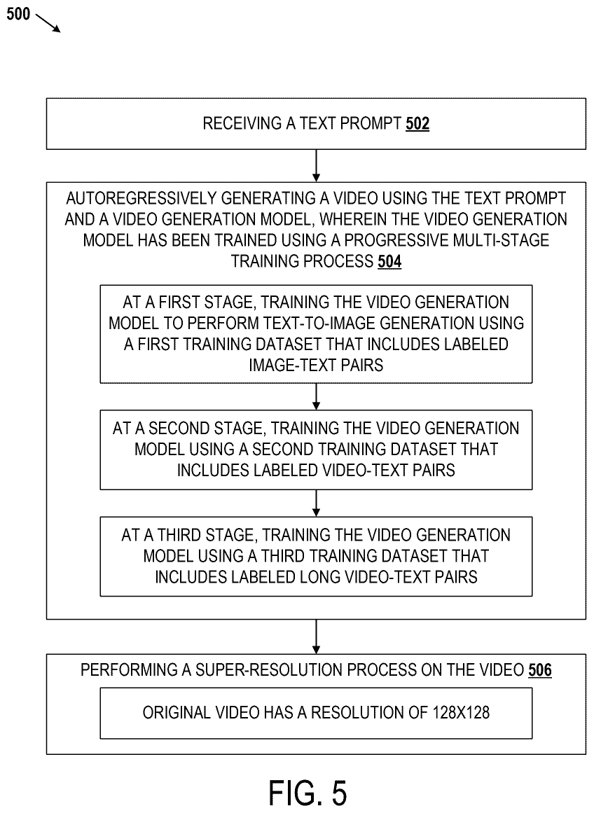

FIG. 5 shows a process flow diagram of an example method 500 for generating a video using an autoregressive video generation model. Various types of video generation models can be utilized. In some implementations, an autoregressive generative language model based model trained by the method 400 of FIG. 4 is implemented. The example method 500 includes, at step 502, receiving a text prompt. At step 504, the example method 500 includes autoregressively generating a video using the text prompt and a video generation model. Generation of a video using an autoregressive video generation model can be performed in various ways. In some implementations, the autoregressive video generation model generates text tokens from the text prompt using a text tokenizer. The text tokens can be used to autoregressively generate the video. For example, a first frame can be generated based on the text tokens, and successive frames can be generated autoregressively based on the text tokens and the previously generated frames.

In some implementations, the video is generated to be longer than the videos on which the autoregressive video generation model was trained. For example, the video generated can be over a minute long using an autoregressive video generation model that was trained on sixty-five-frame videos. Such videos can be generated in various ways. In some implementations, additional tokens passing the length of the training videos can be autoregressively generated, conditioned on the text tokens and the previously generated video tokens. In some implementations, the generated tokens are decoded into a pixel-space video and then a last predetermined number of frames of the pixel-space video is re-encoded using a video tokenizer. New video tokens can then be generated based on the text tokens and the re-encoded video tokens.

The example method 500 optionally includes, at step 506, performing a super-resolution process on the generated video. In some implementations, the generated video initially has a resolution of 128 by 128 pixels. Any type of super-resolution process can be utilized.

The present disclosure describes implementations of an autoregressive generative language model based video generation model, and the training of such a model, that can generate minute-level long videos with consistent appearance, large motion dynamics, and natural scene transitions. Challenges of long video training can be addressed and mitigated using a progressive short-to-long training scheme with loss re-weighting. Inference strategies are provided to extend generated videos beyond training duration. The model can be deployed for various purposes, including to assist visual artists and film producers on video creation, enhancing their efficiency.

In some embodiments, the methods and processes described herein may be tied to a computing system of one or more computing devices. In particular, such methods and processes may be implemented as a computer-application program or service, an application-programming interface (API), a library, and/or other computer-program product.

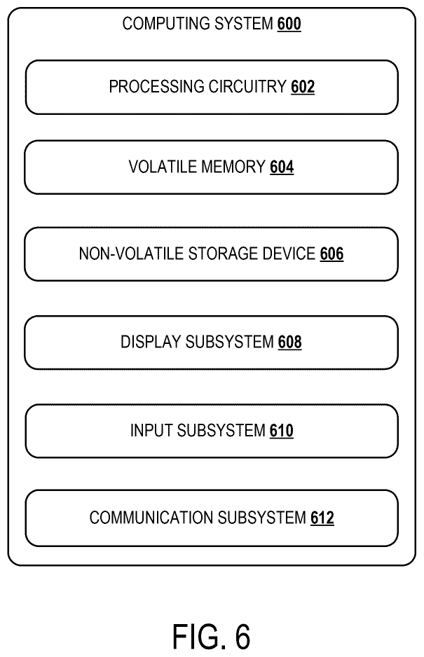

FIG. 6 schematically shows a non-limiting embodiment of a computing system 600 that can enact one or more of the methods and processes described above. Computing system 600 is shown in simplified form. Computing system 600 may embody the computing system 100 described above and illustrated in FIG. 1. Components of computing system 600 may be included in one or more personal computers, server computers, tablet computers, home-entertainment computers, network computing devices, video game devices, mobile computing devices, mobile communication devices (e.g., smart phone), and/or other computing devices, and wearable computing devices such as smart wristwatches and head mounted augmented reality devices.

Computing system 600 includes a logic processor 602 volatile memory 604, and a non-volatile storage device 606. Computing system 600 may optionally include a display subsystem 608, input subsystem 610, communication subsystem 612, and/or other components not shown in FIG. 6.

Logic processor 602 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the logic processor 602 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 606 includes one or more physical devices configured to hold instructions executable by the logic processors to implement the methods and processes described herein. When such methods and processes are implemented, the state of non-volatile storage device 606 may be transformed—e.g., to hold different data.

Non-volatile storage device 606 may include physical devices that are removable and/or built in. Non-volatile storage device 606 may include optical memory, semiconductor memory, and/or magnetic memory, or other mass storage device technology. Non-volatile storage device 606 may include nonvolatile, dynamic, static, read/write, read-only, sequential-access, location-addressable, file-addressable, and/or content-addressable devices. It will be appreciated that non-volatile storage device 606 is configured to hold instructions even when power is cut to the non-volatile storage device 606.

Volatile memory 604 may include physical devices that include random access memory. Volatile memory 604 is typically utilized by logic processor 602 to temporarily store information during processing of software instructions. It will be appreciated that volatile memory 604 typically does not continue to store instructions when power is cut to the volatile memory 604.

Aspects of logic processor 602, volatile memory 604, and non-volatile storage device 606 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 600 typically implemented in software by a processor to perform a particular function using portions of volatile memory, which function involves transformative processing that specially configures the processor to perform the function. Thus, a module, program, or engine may be instantiated via logic processor 602 executing instructions held by non-volatile storage device 606, using portions of volatile memory 604. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 608 may be used to present a visual representation of data held by non-volatile storage device 606. The visual representation may take the form of a graphical user interface (GUI). As the herein described methods and processes change the data held by the non-volatile storage device, and thus transform the state of the non-volatile storage device, the state of display subsystem 608 may likewise be transformed to visually represent changes in the underlying data. Display subsystem 608 may include one or more display devices utilizing virtually any type of technology. Such display devices may be combined with logic processor 602, volatile memory 604, and/or non-volatile storage device 606 in a shared enclosure, or such display devices may be peripheral display devices.

When included, input subsystem 610 may comprise or interface with one or more user-input devices such as a keyboard, mouse, touch screen, camera, or microphone.

When included, communication subsystem 612 may be configured to communicatively couple various computing devices described herein with each other, and with other devices. Communication subsystem 612 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 600 to send and/or receive messages to and/or from other devices via a network such as the Internet.

The following paragraphs provide additional description of the subject matter of the present disclosure. One aspect provides a method for training a video generation model, the method comprising: performing a progressive multi-stage training process, wherein the progressive multi-stage training process comprises a first stage and a second stage, wherein: the first stage comprises training the video generation model to perform text-to-image generation using a first training dataset comprising labeled image-text pairs; and the second stage comprises further training the video generation model using a second training dataset comprising labeled video-text pairs, each comprising a video and a text annotation, wherein further training the video generation model using the second training dataset comprises: for each of the labeled video-text pair: generating at least one text token using a text tokenizer and the text annotation of the labeled video-text pair; generating a plurality of video tokens using a video tokenizer and the video of the labeled video-text pair; autoregressively generating a plurality of frame tokens using the at least one text token; and training the video generation model using loss values calculated from the plurality of frame tokens and the video tokens. training the video generation model using loss values calculated from the plurality of frame tokens and the video tokens. In this aspect, additionally or alternatively, the progressive multi-stage training process further comprises a third stage that includes further training the video generation model using a third training dataset comprising labeled long video-text pairs. In this aspect, additionally or alternatively, a loss re-weighting scheme is applied during the third stage to apply larger loss weights to a token of an earlier frame compared to a token of a later frame. In this aspect, additionally or alternatively, the video tokenizer has been trained to perform temporal compression using convolutional neural network architecture. In this aspect, additionally or alternatively, the labeled long video-text pairs comprise a long video with 65 frames. In this aspect, additionally or alternatively, the long video has a resolution of 128×128, and wherein the video tokenizer can compress the long video into a sequence of 17×16×16 discrete tokens with a vocabulary size of 8192. In this aspect, additionally or alternatively, the video of the labeled video-text pairs of the second training dataset has 17 frames.

Another aspect provides a computing system for training a video generation model, the computing system comprises: processing circuitry and memory storing instructions that, when executed, cause the processing circuitry to: perform a progressive multi-stage training process, wherein the progressive multi-stage training process comprises a first stage and a second stage, wherein: the first stage comprises training the video generation model to perform text-to-image generation using a first training dataset comprising labeled image-text pairs; and the second stage comprises further training the video generation model using a second training dataset comprising labeled video-text pairs, each comprising a video and a text annotation, wherein further training the video generation model using the second training dataset comprises: for each of the labeled video-text pair: generating at least one text token using a text tokenizer and the text annotation of the labeled video-text pair; generating a plurality of video tokens using a video tokenizer and the video of the labeled video-text pair; autoregressively generating a plurality of frame tokens using the at least one text token; and training the video generation model using loss values calculated from the plurality of frame tokens and the video tokens. In this aspect, additionally or alternatively, the progressive multi-stage training process further comprises a third stage that includes further training the video generation model using a third training dataset comprising labeled long video-text pairs. In this aspect, additionally or alternatively, a loss re-weighting scheme is applied during the third stage to apply larger loss weights to a token of an earlier frame compared to a token of a later frame. In this aspect, additionally or alternatively, the video tokenizer has been trained to perform temporal compression using convolutional neural network architecture. In this aspect, additionally or alternatively, the labeled long video-text pairs comprise a long video with 65 frames. In this aspect, additionally or alternatively, the long video has a resolution of 128×128, and wherein the video tokenizer can compress the long video into a sequence of 17×16×16 discrete tokens with a vocabulary size of 8192. In this aspect, additionally or alternatively, the video of the labeled video-text pairs of the second training dataset has 17 frames.

Another aspect provides a method of generating a video using a video generation model, the method comprising: receiving a text prompt; autoregressively generating the video using the text prompt and the video generation model, wherein the video generation model has been trained using a progressive multi-stage training process comprising a first stage and a second stage, wherein: the first stage comprises training the video generation model to perform text-to-image generation using a first training dataset comprising labeled image-text pairs; and the second stage comprises further training the video generation model using a second training dataset comprising labeled video-text pairs. In this aspect, additionally or alternatively, the labeled video-text pairs of the second training dataset comprise a video with 17 frames. In this aspect, additionally or alternatively, the progressive multi-stage training process further comprises a third stage that includes further training the video generation model using a third training dataset comprising labeled long video-text pairs that include a long video with 65 frames. In this aspect, additionally or alternatively, autoregressively generating the video comprises: generating at least one text token using the text prompt and a text tokenizer; generating a first frame token using the at least one text token; autoregressively generating successive frame tokens using previous tokens, wherein the previous tokens at least comprise the first frame token and the at least one text token; and decoding the first frame token and the successive frame tokens into the video. In this aspect, additionally or alternatively, autoregressively generating the video comprises: decoding generated video tokens to a pixel-space video; re-encoding a last predetermined number of frames of the pixel-space video using a video tokenizer; and autoregressively generating successive frame tokens using at least one text tokens and the re-encoded last predetermined number of frames. In this aspect, additionally or alternatively, the method further comprises performing a super-resolution process on the video.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A method for training a video generation model, the method comprising:
performing a progressive multi-stage training process, wherein the progressive multi-stage training process comprises a first stage and a second stage, wherein:
the first stage comprises training the video generation model to perform text-to-image generation using a first training dataset comprising labeled image-text pairs; and
the second stage comprises further training the video generation model using a second training dataset comprising labeled video-text pairs, each comprising a video and a text annotation, wherein further training the video generation model using the second training dataset comprises:
for each of the labeled video-text pair:
generating at least one text token using a text tokenizer and the text annotation of the labeled video-text pair;
generating a plurality of video tokens using a video tokenizer and the video of the labeled video-text pair;
autoregressively generating a plurality of frame tokens using the at least one text token; and
training the video generation model using loss values calculated from the plurality of frame tokens and the video tokens.

2. The method of claim 1, wherein the progressive multi-stage training process further comprises a third stage that includes further training the video generation model using a third training dataset comprising labeled long video-text pairs.

3. The method of claim 2, wherein a loss re-weighting scheme is applied during the third stage to apply larger loss weights to a token of an earlier frame compared to a token of a later frame.

4. The method of claim 2, wherein the video tokenizer has been trained to perform temporal compression using convolutional neural network architecture.

5. The method of claim 2, wherein the labeled long video-text pairs comprise a long video with 65 frames.

6. The method of claim 5, wherein the long video has a resolution of 128×128, and wherein the video tokenizer can compress the long video into a sequence of 17×16×16 discrete tokens with a vocabulary size of 8192.

7. The method of claim 1, wherein the video of the labeled video-text pairs of the second training dataset has 17 frames.

8. A computing system for training a video generation model, the computing system comprises:
processing circuitry and memory storing instructions that, when executed, cause the processing circuitry to:
perform a progressive multi-stage training process, wherein the progressive multi-stage training process comprises a first stage and a second stage, wherein:
the first stage comprises training the video generation model to perform text-to-image generation using a first training dataset comprising labeled image-text pairs; and
the second stage comprises further training the video generation model using a second training dataset comprising labeled video-text pairs, each comprising a video and a text annotation, wherein further training the video generation model using the second training dataset comprises:
for each of the labeled video-text pair:
generating at least one text token using a text tokenizer and the text annotation of the labeled video-text pair;
generating a plurality of video tokens using a video tokenizer and the video of the labeled video-text pair;
autoregressively generating a plurality of frame tokens using the at least one text token; and
training the video generation model using loss values calculated from the plurality of frame tokens and the video tokens.

9. The computing system of claim 1, wherein the progressive multi-stage training process further comprises a third stage that includes further training the video generation model using a third training dataset comprising labeled long video-text pairs.

10. The computing system of claim 9, wherein a loss re-weighting scheme is applied during the third stage to apply larger loss weights to a token of an earlier frame compared to a token of a later frame.

11. The computing system of claim 9, wherein the video tokenizer has been trained to perform temporal compression using convolutional neural network architecture.

12. The computing system of claim 9, wherein the labeled long video-text pairs comprise a long video with 65 frames.

13. The computing system of claim 12, wherein the long video has a resolution of 128×128, and wherein the video tokenizer can compress the long video into a sequence of 17×16×16 discrete tokens with a vocabulary size of 8192.

14. The computing system of claim 8, wherein the video of the labeled video-text pairs of the second training dataset has 17 frames.

15. A method of generating a video using a video generation model, the method comprising:
receiving a text prompt;
autoregressively generating the video using the text prompt and the video generation model, wherein the video generation model has been trained using a progressive multi-stage training process comprising a first stage and a second stage, wherein:
the first stage comprises training the video generation model to perform text-to-image generation using a first training dataset comprising labeled image-text pairs; and
the second stage comprises further training the video generation model using a second training dataset comprising labeled video-text pairs.

16. The method of claim 15, wherein the labeled video-text pairs of the second training dataset comprise a video with 17 frames.

17. The method of claim 16, wherein the progressive multi-stage training process further comprises a third stage that includes further training the video generation model using a third training dataset comprising labeled long video-text pairs that include a long video with 65 frames.

18. The method of claim 15, wherein autoregressively generating the video comprises:
generating at least one text token using the text prompt and a text tokenizer;
generating a first frame token using the at least one text token;
autoregressively generating successive frame tokens using previous tokens, wherein the previous tokens at least comprise the first frame token and the at least one text token; and
decoding the first frame token and the successive frame tokens into the video.

19. The method of claim 15, wherein autoregressively generating the video comprises:
decoding generated video tokens to a pixel-space video;
re-encoding a last predetermined number of frames of the pixel-space video using a video tokenizer; and
autoregressively generating successive frame tokens using at least one text tokens and the re-encoded last predetermined number of frames.

20. The method of claim 15, further comprising performing a super-resolution process on the video.
